(19) United States
(12) Patent Application Publication
(10) Pub. No.: US 2019/0144260 A1
(43) Pub. Date: May 16, 2019

(54) RIDING BRACKET, MANUFACTURING METHOD

(71) Applicant: AMAHORSE TRADING S.R.L., San Giustino (IT)

(72) Inventor: Mauro BENETTI, Lonato del Garda (IT)

(21) Appl. No.: 16/095,196

(22) PCT Filed: Apr. 18, 2017
(86) PCT No.: PCT/IB2017/052205

§ 371 Date: Oct. 19, 2018

(30) Foreign Application Priority Data
Apr. 22, 2016 (IT) 102016000042045

(51) Int. Cl. B68C 3/02

(52) U.S. Cl. CPC B68C 3/02; B68C 2003/0083

(57) ABSTRACT

Horse-riding stirrup (1) comprising a stirrup frame (2) which comprises a hooking portion (4) to a stirrup leather (100), a first side arm (6) and a support arm (8) connected to each other in an incident manner to define a frame compartment (10) engageable by a user's foot; a support element (42) for the user's foot, fitted to the support arm (8) and shape-coupled with an element seat (44) of said arm; The element seat (44) is delimited by an undercut portion (46) which a portion (48) of the support element (42) is wedged into on one side, another portion (50) of said element (42) being constrained to the support arm (8) by means of one or more mechanical fastenings (52) which extend through the thickness of the stirrup frame (2). The invention also relates to an assembly method of a stirrup.

The present invention relates to a horse-riding stirrup and an assembly method of a stirrup.

Horse-riding stirrups of various types are known, which, hanging from corresponding stirrup leathers along the flanks of the horse, make it possible to control the animal in performing various horse-riding disciplines.

The assembly of conventional stirrups involves a number of extremely laborious operations. In addition, some types of stirrups are greatly weakened in their structure during assembly.

The present invention therefore falls into the foregoing context, proposing to provide a riding stirrup and a method of assembly able to overcome the above mentioned disadvantages, and in particular able to provide a stirrup which can be assembled with geometrical couplings functional to preventing weakening of the structure in use.

Such objective is achieved by a horse-riding stirrup according to claim 1, and by a method according to claim 12. The dependent claims show preferred embodiment variants.

The object of the present invention will now be described in detail, with the help of the appended drawings, wherein:

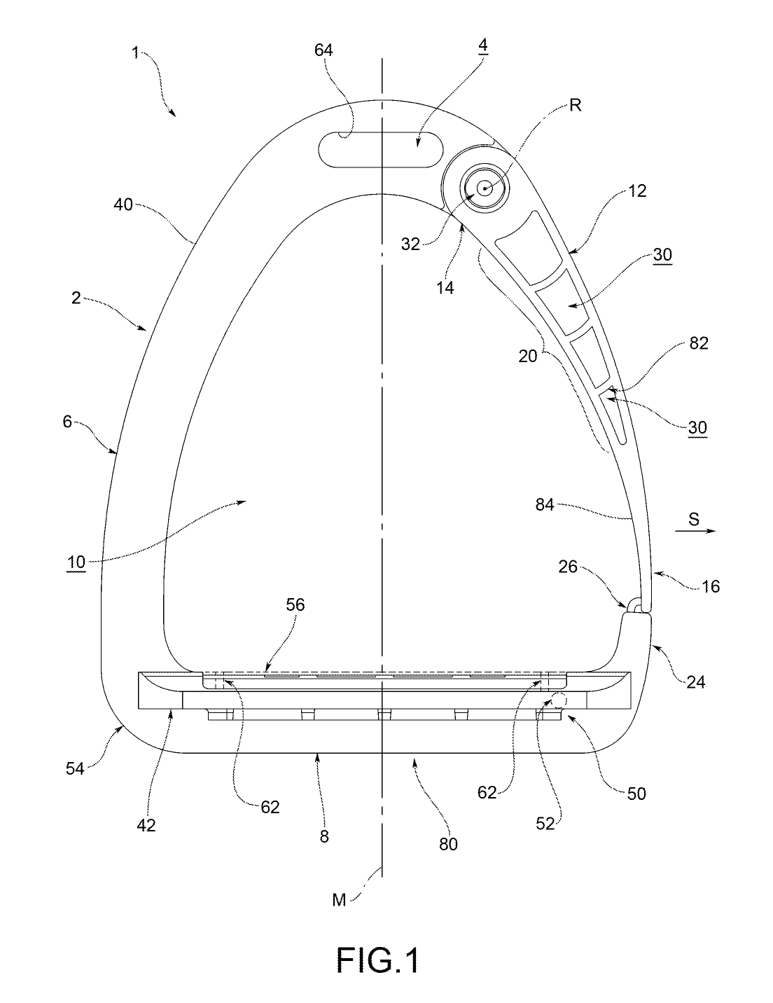

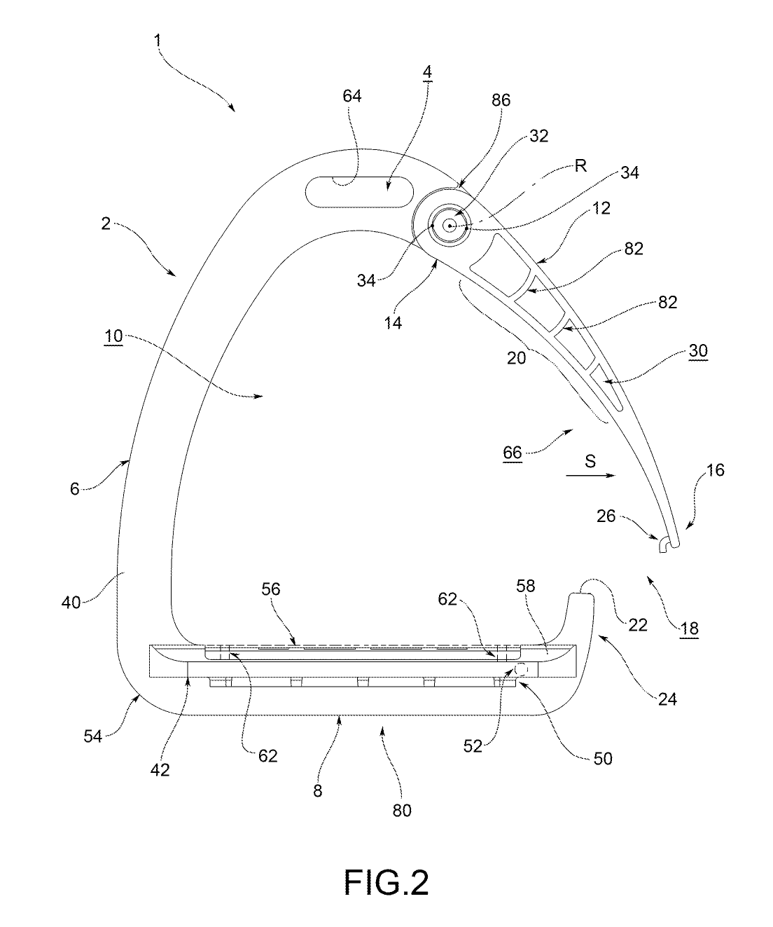

FIGS. 1 and 2 show front views of a stirrup, the subject of the present invention, according to one possible embodiment, where the safety arm is respectively placed in the coupling configuration and in the release configuration;

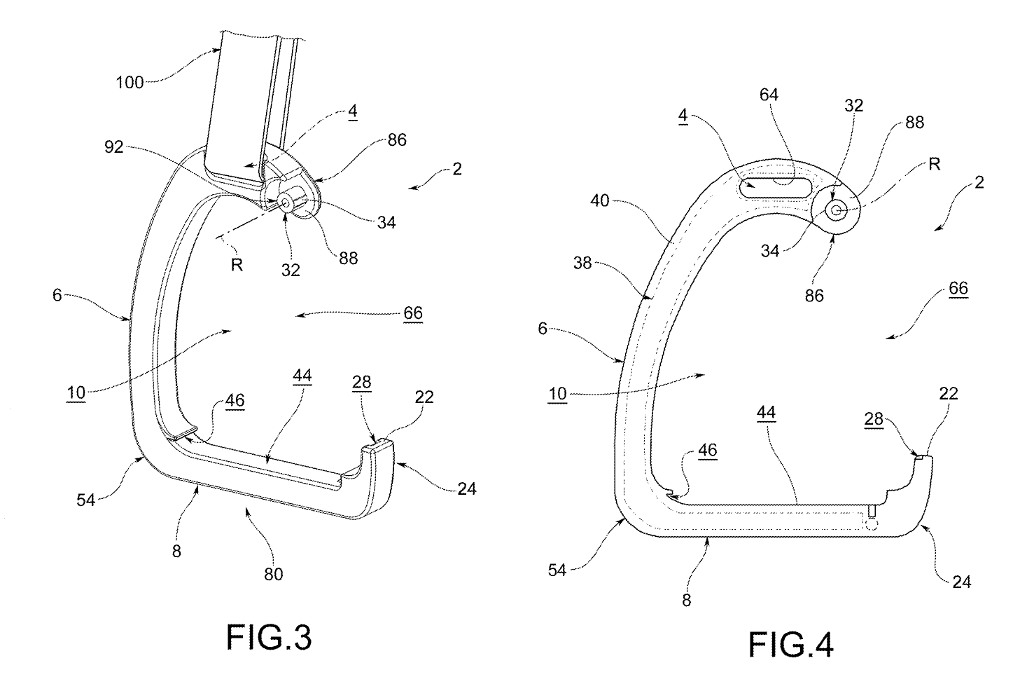

FIGS. 3 and 4 show a stirrup frame according to a possible variant, in perspective and in plan view, where all the other components have been omitted;

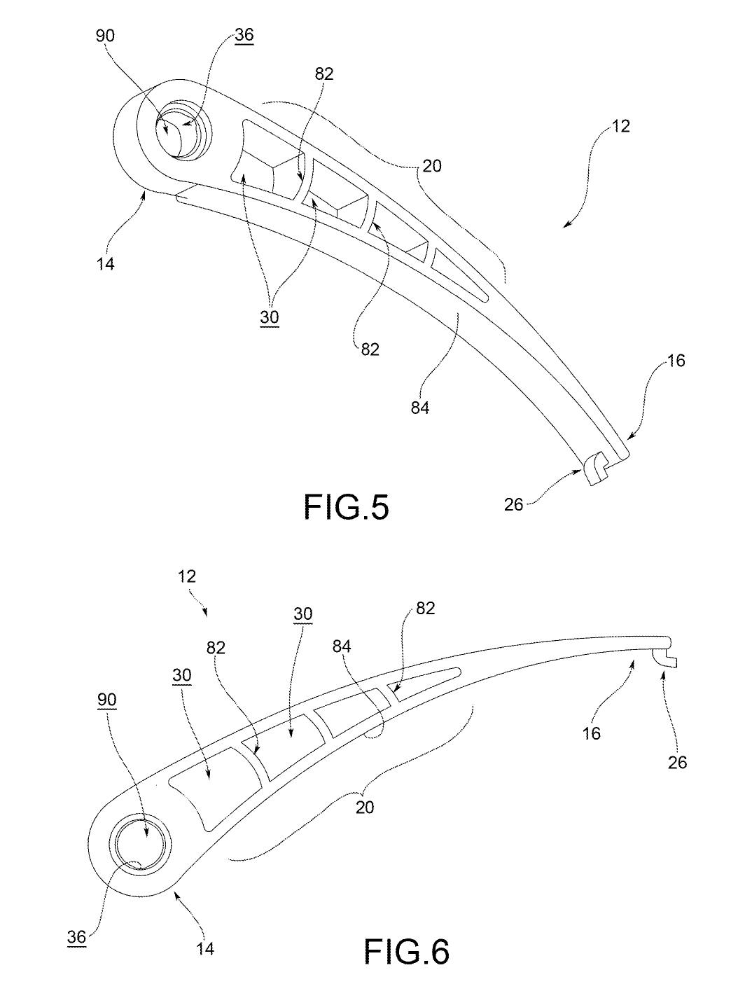

FIGS. 5 and 6 represent a safety arm according to the variant in FIG. 1, in a perspective and plan view;

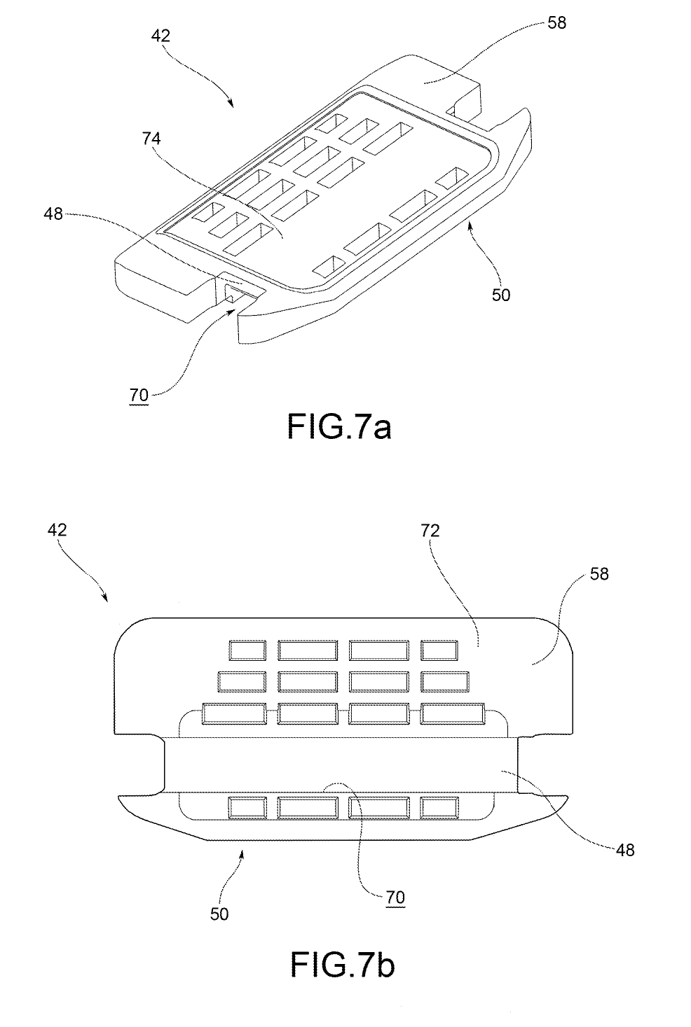

FIGS. 7A and 7B illustrate a perspective and a plan view from below of a support element according to one embodiment;

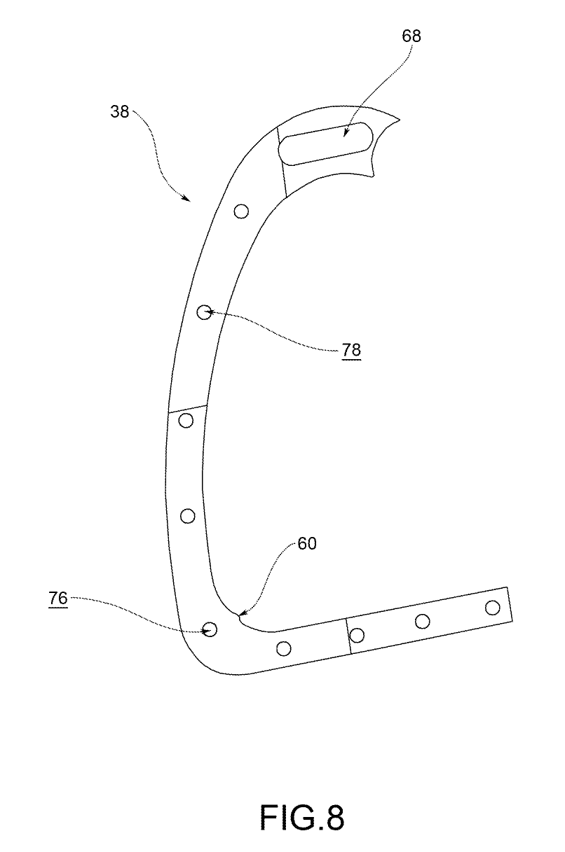

FIG. 8 shows a plan view of a reinforcement core according to one embodiment, for example shown by the dotted line in FIG. 2;

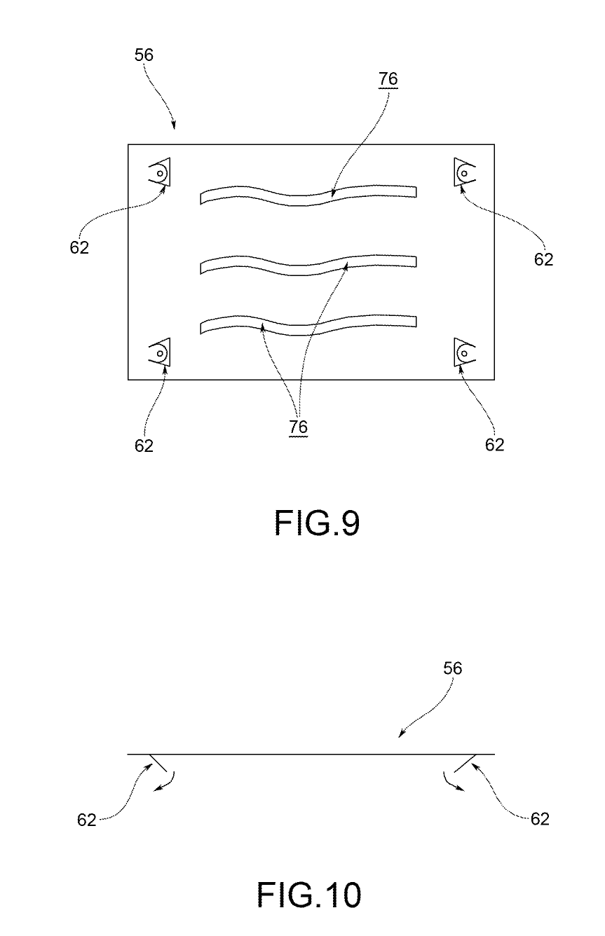

FIGS. 9 and 10 show schematic figures in plan and lateral views of a covering sheet, preferably metallic, attached to the support element according to a possible variant.

With reference to the aforementioned drawings, reference numeral 1 globally denotes a horse-riding stirrup.

Such stirrup 1 comprises a stirrup frame 2 which comprises a hooking portion 4 to a stirrup leather 100 (for example schematically shown in FIG. 3), a first side arm 6 and a support arm 8 connected to each other in an incident manner to define a frame compartment 10 engageable (to be specific, which can be traversed) by a user/rider's foot;

According to a preferred variant, the first side arm and the support arm 8 are integrally joined, substantially in a permanent manner.

According to a preferred further variant, the first side arm 6 and the support arm 8 are made in one piece, at least partially of the same material.

With reference to the variant in FIG. 4, the stirrup frame 2 delimits a frame opening 66 at the side opposite the first side arm 6 where, going into more detail, the first side arm 6 and the support arm 8 are mutually separated.

The stirrup frame 2 could therefore have a single first side arm 6 connecting the hooking portion 4 and the support arm 8. For example, such frame could have a general “C” or “L” shape.

In the embodiment shown, the hooking portion 4 comprises or consists of at least one hole or slot that crosses at least partly (for example completely) the thickness of the stirrup frame 2.

According to one embodiment, an upper edge 64 delimiting the hole or slot of the hooking portion 4 on one side is tilted with respect to a horizontal plane and/or relative to the support arm 8, specifically to enable a better balancing of the stirrup 1 in relation to the stirrup leather 100.

Preferably, the stirrup frame 2 is made mainly or completely of a polymer material.

According to an advantageous variant, the stirrup frame 2 comprises a reinforcement core 38, preferably metallic, to which a polymeric material 40 is co-moulded or over-moulded.

According to a further embodiment not shown, the reinforcement core 38 is only partly incorporated in the polymeric material 40, so that it emerges in part from said material.

According to a further embodiment, the reinforcement core 38 is entirely incorporated in the polymeric material 40. In this regard, such core 38 may delimit a plurality of anchorage openings 78 (e.g. circular) configured to permit the receipt of polymeric material inside them, and thus ensure better adhesion of the co-moulded or over-moulded material to the reinforcement core 38.

In the embodiments shown, the reinforcement core 38 extends from the hooking portion 4 along the first 6 side arm and along at least part of the support arm 8.

Advantageously, the reinforcement core makes at least part of the hooking portion 4, specifically surrounding at least partially the aforesaid hole or slot, or delimiting a core hole or slot 68 having a lumen at least partially aligned with the lumen of the hole or slot of the hooking portion 4.

According to the invention, the stirrup 1 comprises at least a bench or support element 42 for the user's foot, mounted on the support arm 8 and preferably shape-coupled with an element seat 44 of said arm 8.

With reference to FIG. 7 for example, the support element 42 could delimit a longitudinal groove 70 receiving at least part of the support arm 8.

Advantageously, the element seat 44 (e.g. lowered), receives at least a portion of the support element 42.

Preferably the longitudinal groove 70 crosses at least partly (for example completely) the support element 42.

Advantageously, the longitudinal groove 70 is accessible from a lower surface 72 of the support element 42, facing the side opposite a support surface 74 of the user's foot, delimited by said element 42.

The element seat 44 is delimited by an undercut portion 46 in which a portion 48 (for example a tapered portion) of the support element 42 is wedged on one side.

For example, said portion 48 could be housed in the undercut portion 46, after which the support element 42 could be rotated relative to the support arm 8 to occupy the element seat 44 and, more specifically, to accommodate the remaining part of the support arm 8 inside the longitudinal groove 70.

Another portion 50 (for example an opposite portion to the optionally tapered portion 48) of the support element 42 is instead constrained to the support arm 8 using one or more mechanical fastenings 52 which extend through the thickness of the stirrup frame 2.

For example, the mechanical fastenings 52 could comprise one or more screws.

Advantageously, the mechanical fastenings 52 extend through the thickness of the support arm in a direction approximately parallel to the support surface 74 of the support element 42.

Preferably, the mechanical fastenings 52 are arranged at a distance from a connection zone 54 between the first side arm 6 and the support arm 8, for example at an end portion 24 or intermediate portion 80 of the support arm 8.

According to a further advantageous variant, the undercut portion 46 is arranged in the connection zone 54 between the first side arm 6 and the support arm 8. According to this embodiment, the connection zone 54 is therefore preferably devoid of mechanical fastenings which cross the thickness of the aforesaid frame 2, to avoid weakening the mechanical strength of such zone, where the greatest mechanical stresses of the user on the stirrup 1 are concentrated.

According to yet a further variant, the reinforcement core 38 could comprise at least one lug 60 (in the case in point projecting towards the frame compartment 10) which delimits in part the undercut portion 46 and which realizes an abutment surface to prevent the disengagement of the support element.

According to a variant only schematically shown in FIG. 1, the support element 42 may be partially covered by a covering sheet 56, preferably metallic. For example, the covering sheet 56 could be at least partially made of steel.

Optionally, the covering sheet 56 could be perforated through its thickness, or could comprise one or more slits 76, preferably oriented along the support arm 8.

According to one embodiment, the covering sheet 56 comprises coupling portions 62, bent outwards (that is, outside the plane which the sheet extends in) which, according to a further variant, could be at least partly incorporated in a polymer material 58 which the aforesaid support element 42 is at least partly made of.

Advantageously, the coupling portions 62 are cut from the cover sheet 56 itself (e.g. by die-cutting), and then bent towards the outside of the sheet as described above and as shown in FIG. 10.

The stirrup 1 preferably comprises a second side arm 12 or safety arm, comprising an articulation end 14 pivoted to the stirrup frame 2 about an axis of rotation R, and a free end 16 rotatable between a hooking configuration to the support arm 8 and a release configuration of such arm 8.

To such purpose, the stirrup frame 2 delimits a rotation pin 32 around the aforesaid axis R which is preferably housed in the thickness of the frame 2.

More precisely, the rotation pin 32 is positioned at a support appendage 86, thinner than the thickness of the stirrup frame 2.

Advantageously, such support appendage 86 delimits a sliding track 88 for the second side arm, which preferably extends annularly around the pin 32.

In the embodiments shown, a centreline plane M is detectable through the stirrup frame 2 between the first 6 and the second side arm 12, when the latter is in the hooking configuration.

Preferably, the axis of rotation R of the second side arm 12 is substantially parallel (and preferably non-coincidental) to the centreline plane M.

According to a further variant, the axis of rotation R is placed at the hooking portion 4, shifted towards the second arm 12, specifically outside the centreline plane M.

For the variants which provide for a safety arm, in the hooking configuration (for example as schematised in FIG. 1) the second side arm 12 encloses the frame compartment 10 with the first side arm 6 and the support arm 8. Conversely, in the release configuration shown in FIG. 2, the second arm 12 is distanced from the support arm 8 to create a side disengagement opening 18 of the user's foot from the aforesaid frame compartment 10.

In the case in point, in the release configuration the free end 16 of the second side arm 12 is distanced from the support arm 8 to create the aforesaid opening 18.

According to a preferred embodiment, the free end 16 of the second side arm 12 and an end portion 24 of the support arm 8 comprise complementary fastening means 26, 28 which cooperate with each other—as a result of a shape and/or force coupling—in the coupling configuration.

In the variants shown, the complementary fastening means comprise a substantially hooked portion 26 placed at the free end 16 (and preferably facing inwards towards the first side arm 6), and a corresponding recess 28 delimited by the support arm 8.

Advantageously, said recess is facing the frame compartment 10.

According to a variant of the invention, the second side arm 12 comprises at least one flexible portion 20.

According to one embodiment, the second side arm 12 is made mainly or solely of an elastomer material, which makes the flexible portion 20.

According to a further embodiment, between the articulated end 14 and the free end 16, the second side arm 12 delimits one or more structural lightening portions 30 which form the flexible portion.

In the variants shown, the structural lightening portions 30 are shown in the form of a recess extending partially or completely through the thickness of the second side arm 12.

According to a preferred variant, at least one pair of adjacent structural lightening portions 30 may be separated by a separation rib 82.

According to an advantageous embodiment, the flexibility of the flexible portion 20 is adjustable by selecting a higher/lower density distribution of the aforesaid lightening holes 30 along the respective arm 12.

In the coupling configuration, the flexible portion 20 preferably presses the free end 16 against the support arm 8.

This way the portion 20 makes the free end 16 exert a thrust on the support arm 8.

Conversely, to reach the release configuration, the flexible portion 20 advantageously allows the second side arm 12 to bend partially to (preferably: snap) release the free end 16 from the support arm 8, thus creating the side disengagement opening 18.

For example, the movement of the second side arm 12 between the aforesaid configurations may occur as a result of a solicitation on said arm 12 in a direction S opposite to the first side arm 6, towards the outside of the frame compartment 10.

The flexible portion 20—when provided—thus exercises a fundamental function in all configurations, as it actively contributes to the maintenance of the hooking configuration and reactively permits the release of the second side arm 12 from the support arm 8.

According to a preferred variant, in the hooking configuration, the flexible portion 20 the second side arm 12 is pressed (or compressed) between the axis of rotation R of said arm, and a contact surface 22 identified by the support arm 8.

For example, the contact surface 22 may circumscribe partly (for example above) the recess 28 delimited by the support arm 8.

According to one embodiment, in the hooking configuration the second side arm 12 is curved, in particular with its concave surface 84 facing the frame compartment 10.

According to this variant, the flexible portion 20 allows the second arm 12 to temporarily reduce its radius of curvature to release the free end 16 from contact with the support arm 8.

The articulation end 14 of the second side arm 12 is preferably fitted on the rotation pin 32. In the case in point, the articulation end 14 delimits a substantially circular cavity 90, preferably through, embracing the rotation pin 32.

According to a variation not shown, at a free pin end 92 of the rotation pin 32 a mechanical means (e.g. a screw and/or a plate) could be attached to axially hold the second side arm 12 of the stirrup frame 2.

In the embodiments shown, the pin 32 delimits at least one radial projection 34 (or radial cavity) which in the hooking configuration is inserted in at least one radial cavity 36 (or which houses a radial projection) of the articulation end 14 so that the second side arm 12 reaches discrete hooking and release configurations.

The aforementioned objectives are also achieved by a method of assembly of a horse-riding stirrup 1, for example according to any one of the previous embodiments.

Said method comprises the steps of:
providing a stirrup frame 2 which comprises a hooking portion 4 to a stirrup leather 100, a first side arm 6 and a support arm 8 connected to each other in an incident manner to define a frame compartment 10 engageable by a user's foot;
providing a support element 42 for the user's foot;
fitting the support element 42 to the support arm 8 and shape-coupling said element 42 with an element seat 44 of the aforesaid arm 8, where the element seat 44 is delimited by an undercut portion 46;
wedging on one side an optionally tapered portion 48 of the support element 42 into the undercut portion 46;
for example by rotating the support element 42, constraining another portion 50 of said element 42 to the support arm 8 by means of one or more mechanical fastenings 52 which extend through the thickness of the stirrup frame 2.

According to a preferred variant, the step of providing the support element 42 comprises a sub-step of providing a metal covering sheet 56 comprising hooking portions 62, folded outwardly, and a sub-step of incorporating at least part of the hooking portions 62 in a polymer material 58 which said support element 42 is at least partially made of.

According to a further preferred embodiment, the sub-step of providing the metal covering sheet 56 comprises steps of cutting said hooking portions 62 from said covering sheet 56, and folding said portions 62 towards the outside of the sheet.

Optionally, said method comprises further steps of:
providing a second side arm 12 comprising an articulation end 14 and a free end 16;

pivoting the articulation end 14 to the stirrup frame 2 about an axis of rotation R, so that the free end 16 is rotatable between a hooking configuration to the support arm 8 in which the second arm 12 encloses the frame compartment 10 with the first side arm 6 and the support arm 8, and a release configuration of the latter in which the second arm 12 is spaced from the support arm to create a lateral disengagement opening 18 of the user's foot from the aforesaid compartment 10.

Innovatively, the stirrup and the method described make it possible to achieve the objectives set.

In particular, said stirrup and method have been designed with rational geometric couplings to facilitate quick assembly of the stirrup.

The safety arm makes it possible to liberate an additional access to the stirrup compartment so as to allow an easier release of the user's foot.

Advantageously, the stirrup of the present invention is constructively simple, and therefore economical to produce with repetitive and automated operations.

Advantageously, the stirrup of the present invention allows for very precise fine tuning adjustments.

Advantageously, the stirrup of the present invention has been designed to snap open and to be reassembled in the hooking configuration from the release configuration to be used again.

Advantageously, the stirrup of the present invention comprises the second side arm which is held firmly in the hooking configuration and which allows the foot to be firmly held at least on a par with conventional stirrups.

Advantageously, the stirrup of the present invention makes it possible to adjust the flexibility of the second arm in a targeted and precise manner.

Advantageously, through appropriate selection of the structural lightening portions, and therefore in a manner of little invasiveness, the stirrup of the present invention makes it possible to design a range of products for different users, for example of different weights.

Advantageously, the stirrup of the present invention has been conceived to be assembled without weakening the major structural components.

Advantageously, the stirrup of the present invention has high mechanical resistance.

Advantageously, the stirrup of the present invention is extremely light.

Advantageously, the stirrup of the present invention permits a good balance with respect to the stirrup leathers, despite being an asymmetrical component in relation to a central plane.

Advantageously, the presence of a non-slip element improves the grip on the stirrup bar.

A person skilled in the art may make variations or replacements of elements with others functionally equivalent to the aforementioned embodiments of the stirrup and of the method so as to satisfy specific requirements.

Such variants are also contained within the scope of protection as defined by the following claims.

In addition, each variant described as belonging to a possible embodiment may be realised independently of the other embodiments described.

1. A horse-riding stirrup comprising:
a stirrup frame which comprises a hooking portion to a stirrup leather, a first side arm and a support arm connected to each other in an incident manner to define a frame compartment engageable by a user's foot;
a support element for the user's foot, fitted to the support arm and shape-coupled with an element seat of said arm;
wherein the element seat is delimited by an undercut portion which an optionally tapered portion of the support element is wedged into one side, another portion of said element being constrained to the support arm by means of one or more mechanical fastenings, for example comprising one or more screws, which extend through the thickness of the stirrup frame.

2. The stirrup according to the preceding claim, wherein the stirrup frame has a general “C” or “L”, shape, said frame having a single first side arm which connects the hooking portion and the support arm.

3. The stirrup according to claim 1, wherein the undercut portion is placed in a connection zone between the first side arm and the support arm, said zone being free of mechanical fastenings passing through the thickness of said frame to prevent weakening its mechanical strength.

4. The stirrup according to claim 1, wherein the stirrup frame is made mainly or completely of a polymer material.

5. The stirrup according to claim 1, wherein the stirrup frame comprises a reinforcement core, preferably metallic, to which a polymer material is co-moulded or over-moulded, said reinforcement core extending from the hooking portion along the first side arm and along at least part of the support arm.

6. The stirrup according to claim 1, wherein the reinforcement core comprises at least one lug projecting towards the frame compartment which delimits in part the undercut portion and which makes an abutment surface to prevent the disengagement of the support element.

7. The stirrup according to claim 1, wherein the support element delimits, for example underneath, a longitudinal groove which receives at least part of the support arm.

8. The stirrup according to claim 1, wherein the support element is partially covered by a metal covering sheet, for example of steel, hooking portions folded outwards of said sheet being at least partially embedded in a polymer material which said support element is at least partially made of.

9. The stirrup according to claim 1, comprising a second side arm comprising an articulation end pivoted to the stirrup frame about an axis of rotation, and a free end rotatable between a hooking configuration to the support arm in which the second arm encloses the frame compartment with the first side arm and the support arm, and a release configuration of the latter, in which said second arm is spaced from the support arm to create a lateral disengagement opening of the user's foot from said compartment.

10. The stirrup according to the preceding claim, wherein the second side arm comprises at least one flexible portion which in the coupling configuration presses the free end in abutment with the support arm and which, in order to achieve the release configuration, allows the second side arm to bend in part, to snap-disengage the free end from the support arm, for example as a result of a stress in a direction opposite the first side arm.

11. The stirrup according to claim 1, comprising a second side arm comprising an articulation end pivoted to the stirrup frame about an axis of rotation, and a free end rotatable between a hooking configuration to the support arm in which the second arm encloses the frame compartment with the first side arm and the support arm, and a release configuration of the latter, in which said second arm is spaced from the support arm to create a lateral disengagement opening of the user's foot from said compartment, wherein a centreline plane (M) is detectable through the stirrup frame between the first and the second side arm in the hooking configuration, the axis of rotation being located at the hooking portion, shifted towards said second arm outside said plane.

12. A method of assembling a stirrup for horse-riding, for example according to any of the preceding claims, comprising the steps of:
providing a stirrup frame which comprises a hooking portion to a stirrup leather, a first side arm and a support arm connected to each other in an incident manner to define a frame compartment engageable by a user's foot;
providing a support element for the user's foot;
fitting the support element to the support arm and shape-coupling said element with an element seat of said arm, the element seat being delimited by an undercut portion;
wedging on one side an optionally tapered portion of the support element in the undercut portion;
constraining another portion of said element to the support arm by means of one or more mechanical fastenings, for example comprising one or more screws, which extend through the thickness of the stirrup frame.

13. The method according to claim 12, wherein the step of providing the support element comprises a sub-step of providing a metal covering sheet comprising hooking portions, folded outwardly, and a sub-step of incorporating at least part of the hooking portions in a polymer material which said support element is at least partially made of.

14. The method according to claim 13, wherein the sub-step of providing the metal covering sheet comprises steps of cutting said hooking portions from said covering sheet, and folding said portions towards the outside of the sheet.

15. The method according to claim 12, comprising the steps of:
providing a second side arm comprising an articulation end and a free end;
pivoting the articulation end to the stirrup frame about an axis of rotation, so that the free end is rotatable between a hooking configuration to the support arm in which the second arm encloses the frame compartment with the first side arm and the support arm, and a release configuration of the latter, in which said second arm is spaced from the support arm to create a lateral disengagement opening of the user's foot from said compartment.
